(19) United States
(12) Patent Application Publication
(10) Pub. No.: US 2009/0043065 A1
(43) Pub. Date: Feb. 12, 2009

(54) Singlet oxygen oxidized materials and methods of making and using same

(76) Inventors: Olga Khabashesku, Houston, TX (US); Billy Ellis, Spring, TX (US)

Correspondence Address: FINA TECHNOLOGY INC, PO BOX 674412, HOUSTON, TX, 77267-4412, US

(21) Appl. No.: 11/835,126

(22) Filed: Aug. 7, 2007

(51) Int. Cl. B01J 19/12; C08F 112/08

(52) U.S. Cl. 526/347.1; 204/157.15

(57) ABSTRACT

A method comprising irradiating a donor molecule with light to form an activated donor molecule, contacting the activated donor molecule with an acceptor molecule to form an activated acceptor molecule, and contacting the activated acceptor molecule with a substrate to generate an oxidized substrate, wherein the donor molecule is in the solid phase and the activated acceptor molecule is in the gas phase.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

1. Technical Field

This disclosure relates to systems and methods for the production and use of singlet oxygen. More specifically, this disclosure relates to methods for the oxidation of substrates and uses of same.

2. Background

Ground-state oxygen is in the triplet state (indicated by the superscripted “3” in ³O₂). The two unpaired electrons in ground state oxygen have parallel spins, a characteristic that, according to rules of physical chemistry, does not allow them to react with most molecules. Thus, ground-state or triplet oxygen is not very reactive. However, triplet oxygen can be activated by the addition of energy, and transformed into a reactive oxygen species, for example singlet oxygen (indicated by the superscripted “1” in ¹O₂).

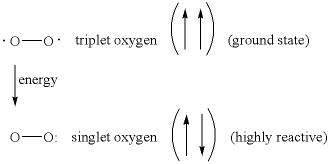

This reaction can also be written in this form:

³O₂+energy→¹O₂*

Singlet oxygen is a reactive molecule that may be used to functionalize a variety of molecules. An ongoing need exists for methods of production of singlet oxygen and for uses thereof such as for the functionalization of molecules.

### BRIEF SUMMARY

Disclosed herein is a method comprising irradiating a donor molecule with light to form an activated donor molecule, contacting the activated donor molecule with an acceptor molecule to form an activated acceptor molecule, and contacting the activated acceptor molecule with a substrate to generate an oxidized substrate, wherein the donor molecule is in the solid phase and the activated acceptor molecule is in the gas phase. The donor molecule may comprise a photosensitizer and the acceptor molecule comprises molecular oxygen. The activated acceptor molecule may comprise an activated oxygen species. The photosensitizer may comprise a photosensitive dye. The photosensitive dye may comprise a xanthene dye, a thiazine dye, an acridine dye or combinations thereof. The photosensitive dye may be present in an amount of from 0.01 g/per 100 g (gram) of support to 2.5 g/per 100 g of support. The light may have a wavelength of from 300 nm to 1400 nm. The activated acceptor molecule may comprise singlet oxygen. The substrate may comprise a diene. The diene may comprise an allylic hydrogen, an elastomer, or both. The oxidized substrate may comprise a peroxide, a hydroperoxide, an epoxide or combinations thereof. The peroxide may be present in an amount of from about 1 μg (microgram) to about 100 μg of active oxygen per 1 g of solution. The irradiating and the contacting may occur in situ.

Further disclosed herein is a method comprising contacting molecular oxygen with an activated photosensitizer to produce singlet oxygen, contacting the singlet oxygen with at least one diene to produce an oxidized diene, and contacting at least one monomer and the oxidized diene under conditions suitable for the formation of a polymer. The photosensitizer may comprise an immobilized photosensitive dye. The diene may comprise an elastomeric diene, a diene having an allylic hydrogen, or both.

Further disclosed herein is a method comprising irradiating molecular oxygen and a photosensitizer with light to form an activated oxygen species, and contacting the activated oxygen species with a substrate to form an oxidized substrate, wherein the irradiating and contacting occur in situ. The irradiating and contacting may occur in the same reaction zone. The irradiating and contacting may occur in different reaction zones in close proximity.

Further disclosed herein is a method comprising contacting a photosensitive dye with a support to generate a supported photocatalyst, and contacting the supported photocatalyst with molecular oxygen in the presence of a light source to produce an activated oxygen species. The photosensitive dye may comprise a xanthene dye, a thiazine dye, an acridine or combinations thereof. The support may comprise talc, inorganic oxides, clays and clay minerals, ion-exchanged layered compounds, diatomaceous earth compounds, zeolites, a resinous support material, silica, alumina, or combinations thereof. The support material may comprise a translucent material. The support material may comprise silica. The surface area of the support may be equal to or greater than 100 m²/g. The support material may comprise alumina. The surface area of the support may be equal to or greater than 200 m²/g. The supported photocatalyst may be prepared by incipient wetness impregnation. The supported photocatalyst may be prepared by spray drying. The method may further comprise heating the supported photocatalyst. The heating may be in a temperature range of from 60° C. to 110° C. for a period of from 12 to 48 hours. The photosensitive dye may be associated primarily with the outer layer of the support. Equal to or greater than approximately 80% of the dye may be located on or near the surface of the support. The photosensitive dye may be associated with the support in amounts of from 0.01 g per 100 g of support to 2.5 g per 100 g of support. The activated oxygen species may comprise singlet oxygen. Light from the light source may have a wavelength of from 300 nm to 1400 nm.

Further disclosed herein is a method comprising spraying a photosensitive dye on a silica support to form a supported photosensitive dye, drying the supported photosensitive dye, and irradiating the supported photosensitive dye in the presence of molecular oxygen to produce singlet oxygen. The photosensitive dye may comprise a xanthene dye, a thiazine dye, an acridine or combinations thereof. The support may comprise talc, inorganic oxides, clays and clay minerals, ion-exchanged layered compounds, diatomaceous earth compounds, zeolites, a resinous support material, silica, alumina, or combinations thereof.

Further disclosed herein is a method comprising contacting a photosensitive dye with a support under conditions suitable to generate a supported photosensitive dye, contacting the supported photosensitive dye with a substrate and molecular oxygen to from a reactive mixture, and irradiating the reactive mixture with light under conditions suitable to form an oxidized substrate.

Further disclosed herein is a method comprising contacting molecular oxygen with an activated photosensitizer in a reaction zone to produce singlet oxygen, contacting the singlet oxygen with at least one diene in the reaction zone to produce at least one oxidized diene, and contacting a styrene monomer with the oxidized diene under conditions suitable for the formation of a styrene polymer. The photosensitizer may comprise a xanthene dye, a thiazine dye, an acridine dye or combinations thereof. The photosensitizer may be supported. The support may comprise talc, inorganic oxides, clays and clay minerals, ion-exchanged layered compounds, diatomaceous earth compounds, zeolites, a resinous support material, silica, alumina, or combinations thereof. The photosensitizer may be activated by irradiation with light. The light may have a wavelength of from 300 nm to 1400 nm. The diene may comprise an allylic hydrogen. The method may further comprise contacting the styrene monomer with at least one extrinsic polymerization initiator. The extrinsic polymerization initiator may comprise diacyl peroxides, peroxydicarbonates, monoperoxycarbonates, peroxyketals, peroxyesters, dialkyl peroxides, hydroperoxides or combinations thereof. The reaction zone may further comprise glass beads.

Further disclosed herein is a method comprising contacting molecular oxygen with an activated photosensitizer to produce singlet oxygen in a first reaction zone, contacting the singlet oxygen with at least one diene to produce an oxidized diene in a second reaction zone, and contacting a styrene monomer with the oxidized diene under conditions suitable for the formation of a styrene polymer. The activated photosensitizer may comprise a supported photosensitive dye. The photosensitive dye may comprise a xanthene dye, a thiazine dye, an acridine dye or combinations thereof. The first reaction vessel may further comprise glass beads. The ratio of glass beads to supported photosensitizer may be from 1:1 to 1:4 by volume. The second reaction zone may comprise a bubble flow reactor. The bubble flow reactor may have an airflow of from 0.5 to 10 L/min. The diene may further comprise an elastomer. The polymer may be a high-impact polystyrene.

Further disclosed herein is a method comprising contacting molecular oxygen with an activated photosensitizer to produce singlet oxygen, contacting the singlet oxygen with at least one diene to produce at least one oxidized diene, wherein the singlet oxygen is produced and reacted with the diene in situ, and contacting a styrene monomer with the oxidized diene under conditions suitable for the formation of a styrene polymer.

The foregoing has outlined rather broadly the features and technical advantages of the present disclosure in order that the detailed description of the embodiments that follow may be better understood. Additional features and advantages of the embodiments will be described hereinafter that form the subject of the claims of the disclosure. It should be appreciated by those skilled in the art that the conception and the specific embodiments disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

FIG. 1 is a schematic of a photosensitization process.

FIGS. 2A and 2B are embodiments of reactors for the production of an oxidized substrate.

FIGS. 3 and 4 are embodiments of reactors for the production of oxidized dienes.

FIG. 5 is a plot of the percent solids formed as a function of time for the samples from Example 8.

### DETAILED DESCRIPTION

Disclosed herein are methods and catalysts for producing activated oxygen and methods for using same. In an embodiment, the catalysts are supported photosensitizers and the method comprises contacting said catalysts with molecular oxygen to generate activated oxygen. The activated oxygen may be contacted with a substrate under conditions suitable to generate an oxidized substrate. The oxidized substrate may serve as an end-use compound or may be reacted further to produce a variety of end-use compounds. The catalysts, singlet oxygen, substrates and oxidized substrates will be described in more detail later herein.

In an embodiment, a method of producing an oxidized substrate comprises contacting a catalyst with molecular oxygen to generate an activated oxygen species. In an embodiment, the catalyst comprises a photosensitizer. A photosensitizer, also referred to herein as the donor, refers to a light-absorbing substance that may be photoexcited and used to create an excited state in another molecule, also referred to herein as the acceptor molecule. For example, a photosensitizer (i.e., donor) when exposed to a light source may undergo photoexcitation and subsequently contact other molecules (i.e., acceptors) and transfer at least a portion of its energy to generate molecules having an excited electronic state. Various embodiments employing photosensitizers are described herein with the understanding that one or more other donor materials may be employed alternatively or additionally to photosensitizers.

In an embodiment, the donor comprises any material whose excited state is at a higher energy than the acceptor and is capable of transferring energy to the acceptor. Alternatively, the donor comprises a photosensitive dye. Suitable photosensitive dyes include without limitation xanthene dyes, illustrative examples of which are rose Bengal (see Structure 1), rhodamine B, erythrosin, eosin and fluorescein; thiazine dyes, an example of which is methylene blue (see Structure 2); acridines, an example of which is acridine orange (see Structure 3); or combinations thereof. Alternatively, the photosensitive dyes comprise rose Bengal, methylene blue, acridine orange or combinations thereof.

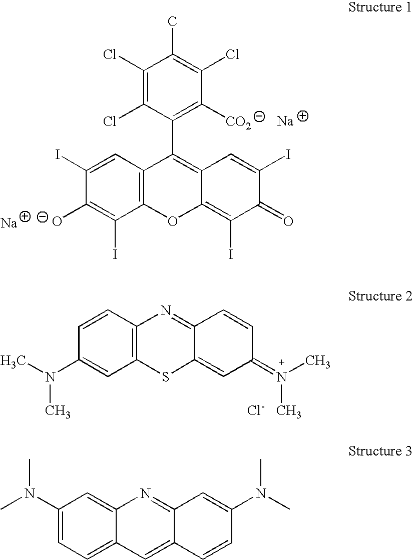

In an embodiment, the catalyst further comprises a support material supporting one or more donor materials such as a photosensitive dye. Typical support materials may include talc, inorganic oxides, clays and clay minerals, ion-exchanged layered compounds, diatomaceous earth compounds, zeolites or a resinous support material, such as a polyolefin, for example. Alternatively, the support material comprises silica, alumina, or combinations thereof. Such supports may be in form of pellets and/or beads having any variety of shapes and/or sizes. In some embodiments, the support material for a photosensitizer may be a translucent material. In an embodiment, the support material comprises silica having a surface area of equal to or greater than 100 m²/g, alternatively equal to or greater than 150 m²/g, alternatively equal to or greater than 500 m²/g. In another embodiment, the support material comprises alumina having a surface area of equal to or greater than 200 m²/g, alternatively equal to or greater than 300 m²/g, alternatively equal to or greater than 400 m²/g.

As will be understood by one of ordinary skill in the art, the structural strength of the support is a practical consideration. For example, amorphous silica support is known to break in polar solvents such as for example methylene chloride. Without wishing to be limited by theory, disintegration of amorphous silica and mica in polar solvents, such as water and methylene chloride, is a surface phenomenon caused by creating a disjoining force in thin films of liquids on a solid surface having micro-capillaries and/or a layered structure. Positive wedge pressure in the capillaries along with the heat released during wetting of the silica surface may contribute to silica breakage. This is described in Vazquez, R., et al., Colloid Interface Science (2005), Volume 284 No. 2: pages 652-7, which is incorporated by reference herein in its entirety. Consequently, the support may be chosen such that the integrity of the support is not compromised by the catalyst preparation process or by the employment of the catalyst in a user-desired process.

In an embodiment, a catalyst comprising one or more donor materials (e.g., photosensitizer) and a support may be prepared by various techniques suitable and operable to add the donor materials to the support. For example, the catalyst may be prepared by contacting the photosensitizer and support under conditions that allow for the photosensitizer to become associated with the support. In an embodiment, the photosensitizer may be contacted with the support using a technique such as incipient wetness impregnation. During incipient wetness impregnation, the pores of the support become substantially filled with the photosensitizer material. Other techniques such as soaking may also be employed to contact the support with the photosensitizer.

In an embodiment, the catalyst is produced by spraying a photosensitizer-containing solution onto a support. In such embodiments, the photosensitizer may be dissolved in a solvent and the solution sprayed onto a support. The solvent may be any material compatible with the catalyst and support and may be chosen based on a variety of factors to meet the needs of the process. For example, the solvent may be chosen based on the solubility of the catalyst in the solvent, the toxicity of the solvent, the relative cost of the solvent, etc. In an embodiment, the photosensitizer is a dye of the type described previously herein and the solvent is a non-aqueous solvent. Alternatively, the photosensitizer is a dye of the type described previously herein and the solvent is an aqueous solvent.

The solution comprising the solvent and photosensitizer may be contacted with a support using a sprayer. Sprayers and spraying devices utilizing pressure nozzles, atomizers and the like are known to one of ordinary skill in the art. The support having been subjected to spraying with the photosensitizer-containing solution may then be dried to remove any excess solvent. The drying may be carried out using any drier device and under any conditions compatible with both the photosensitizer and support. For example, the drying may be carried out in a vacuum oven at a temperature of from 60° C. to 80° C., alternatively from 80° C. to 100° C., alternatively from 100° C. to 110° C. for a period of equal to or greater than 12 hour, alternatively equal to or greater than 24 hours, alternatively equal to or greater than 48 hours, alternatively for a period sufficient to remove equal to or greater than 95% of the solvent. Hereinafter, the photosensitizer associated with the support may be referred to as the supported photocatalyst or catalyst. The photosensitizer concentration on the support (i.e., the catalyst loading) may vary depending on the molecular weight of the photosensitizer. For example, the catalyst prepared as described herein may have the photosensitizer associated with the support in amounts of from 0.01 g to 2.5 g per 10 g of support, alternatively from 20 mg to 200 mg per 100 g of support, alternatively from 10 mg to 20 mg per 100 g of support. Such amounts may be determined using any technique known in the art for determining catalyst loading. For example when the dye is loaded on support by incipient wetness impregnation, the dye loading (L), may be calculated using equation 1:

L[g]=C[g/cc]×PV[cc] Equation 1

where PV is the pore volume of support, and C is the concentration of dye in impregnating solution. Alternatively, the supported dye may be subjected to a basic solution which hydrolyzes and cleaves the dye from silica support. The solution may then be separated from the solid support material by simply decanting the liquid and the amount of free dye in solution measured spectroscopically; for example by determining the UV-Vis absorption spectra of the liquid. This procedure is described by S. Tamagaki, C E. Leisner, D. C. Neckers, in J. Org. Chem. (1980), Volume 45, No. 9, page 1573 which is incorporated by reference herein in its entirety.

A catalyst prepared by spray drying as described herein may have an increased catalytic efficiency when compared to catalysts prepared by other techniques such as wetness impregnation. Without wishing to be limited by theory, spray drying the photosensitizer-containing solution such that the photosensitizer becomes associated primarily with the surface of the support may allow for a greater amount of photosensitizer accessible to the light and/or the acceptor as opposed to techniques where a larger percentage of the photosensitizer may become associated with the interior of the support and thus be less accessible to contacting with the light and/or acceptor. In some embodiments, equal to or greater than approximately 80% of the photosensitizer dye is located on or near the surface of the support.

In an embodiment, the catalyst prepared as described may be employed immediately in a user-desired process. Alternatively, the catalyst may be stored for some duration of time prior to being employed in a user-desired process. The catalyst may be stored under conditions that promote maintenance of catalyst activity during storage. For example, the catalyst may be stored in a vessel, container, or storage area in the absence of light and/or in an inert atmosphere such as under nitrogen gas.

In an embodiment, the catalyst prepared as described herein may be excited (e.g., photoexcited) to produce an activated catalyst which in turn may be employed in a variety of processes. Photoexcitement of the catalyst may occur by irradiation of the catalyst with light of any wavelength compatible with the components of the system, the photosensitive dye excitation wavelengths, and the user-desired processes. In an embodiment, the catalyst prepared as described herein may be contacted with a substrate by addition of the catalyst to a vessel containing the substrate. Alternatively, the catalyst may be a component of a reactor, such as a fixed bed reactor, wherein the catalyst is held in a vessel and other reaction components are introduced to and removed from the vessel containing the catalyst. The reactor may comprise any vessel constructed of any material compatible with the components of the user-desired process. Additionally, the reactor may allow for transmittance of light such as during the photoexcitation of the catalyst. For example, the reactor may comprise a glass column. In some embodiments, glass beads may combined with the catalyst and the mixture (i.e., catalyst and glass beads) used as a component of a reactor. Without wishing to be limited by theory, the glass beads may channel and/or reflect light from the light source during photoexcitation of the catalyst thus, increasing the exposure of the catalyst to the light source. In such embodiments, the glass beads may be present such that the ratio of glass beads to catalyst is from 1:1, alternatively 1:2, alternatively 1:4 by volume.

A catalyst comprising a photosensitizer and a support may be photoexcited by exposure to a light source and contacted with at least one acceptor molecule to produce an excited acceptor molecule. In an embodiment, the acceptor molecule comprises molecular oxygen and the excited acceptor molecule comprises singlet oxygen.

Singlet oxygen, designated ¹O₂, is the common name used for the two metastable states of molecular oxygen with a higher energy than the ground state, triplet oxygen. The two metastable states of ¹O₂ differ only in the spin and occupancy of oxygen's two degenerate antibonding π-orbitals. The O₂(b¹Σ_{g}⁺) excited state is very short lived and relaxes quickly to the lowest lying excited stated, O₂(a¹Δ_{g}). Thus, the O₂(a¹Δ_{g}) state is commonly referred to as singlet oxygen.

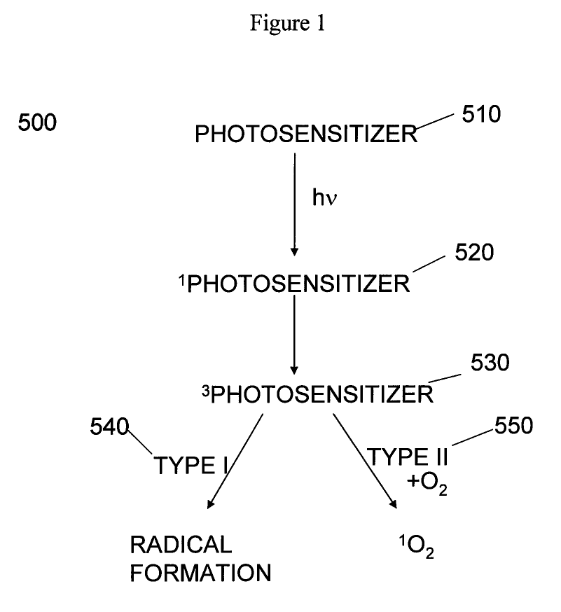

¹O₂ may be generated by any process known to one of ordinary skill in the art. Alternatively, ¹O₂ may be generated using a photosensitization process employing a catalyst of the type described previously herein. FIG. 1 depicts a typical photosensitization process, 500. A photosensitizer 510 is irradiated to its singlet excited state 520 using a light source, followed by conversion, termed intersystem crossing, to its triplet excited state 530. The triplet excited photosensitizer may undergo radical reactions 540 (Type I process) or produce singlet oxygen 550 (Type II process). In an aspect, the type II process is conducted at a low substrate concentration and high oxygen concentration. For a more complete explanation of energy-transfer mechanisms, see G. J. Ferraudi, Elements of Inorganic Photochemistry, John Wiley and Sons, p. 87-88, 96, 111 (1988), which is incorporated by reference herein in its entirety.

The light source may be any light source capable of transmitting light in the wavelength absorbed by and effective to excite the photosensitive dye. For example, the light source may be an ambient light source, alternatively the light source is a lamp such as a tungsten lamp capable of emitting light having wavelengths from 300 nm to 1400 nm, alternatively, the light source may be a lamp capable of emitting light having wavelengths from 400 nm to 750 nm.

The photosensitization of molecular oxygen to produce ¹O₂ using a photosensitive dye may be a continuous process that occurs for the duration of time equivalent to the time period for which the dye is contacted with a source of molecular oxygen and irradiated with the light source. The process of ¹O₂ generation may be terminated by removing the source of molecular oxygen and/or removing the light source. In an embodiment, the ¹O₂ generated by the methodology disclosed herein is in the gas phase. The half-life (τ_{1/2}) of ¹O₂ as an isolated molecule is approximately 45 minutes however, in the gas phase the τ_{1/2} is between 1 and 10⁻⁵ s depending on the nature of the gas.

The amount of ¹O₂ generated using the methodologies disclosed herein may be determined using any means known to one of ordinary skill in the art for quantitating ¹O₂. For example, when the singlet oxygen is used to generate an oxidized material such as a peroxide, ASTM D-2340 may be used for determining peroxide concentration in the solution. As will be understood by one of ordinary skill in the art, the amount of singlet oxygen generated by the methodologies disclosed herein will depend on a variety of factors including for example, the nature and amount of photosensitive dye and the irradiation time.

The ¹O₂ generated as disclosed herein may be contacted with a substrate to form an oxidized substrate, alternatively a peroxidated substrate. In an embodiment, the substrate is present in the same reaction zone as the ¹O₂ when the ¹O₂ is formed. In an embodiment, the reaction zone is a vessel, container, or reactor housing the components necessary to generate ¹O₂. In an alternative embodiment, the substrate is present in one or more reaction zones that are in fluid communication with the first reaction zone where the ¹O₂ is generated. In such an embodiment, at least some portion of the ¹O₂ generated in the first reaction zone may enter the additional reaction zones and react with (i.e., oxidize) a substrate present in the any of the reaction zones. Whether employing a reactor configuration wherein the ¹O₂ is generated and reacted with a substrate in the same reaction zone and/or in one or more additional reaction (e.g., oxidation) zones in fluid communication with the reaction zone wherein the ¹O₂ is generated, the ¹O₂ is considered to be generated and reacted with the substrate in situ. That is, the ¹O₂ is considered to be reacting in situ with the substrate if the reaction occurs in physical and/or temporal proximity (e.g., close proximity) to the formation of the ¹O₂. In an embodiment, in situ reaction of ¹O₂ with a substrate occurs in equal to or less than 1 hour of production of the ¹O₂, alternatively in equal to or less than about 50, 40, 30, 20, 10, 5, 3, 2, 1, or 0.5 minutes from production of the ¹O₂, alternatively in equal to or less than about 30, 20, 10, 5, 3, 2, 1, 0.5, 0.1, 0.01, or 0.001 seconds from production of the ¹O₂ In an embodiment, the in situ reaction of ¹O₂ with a substrate occurs in equal to or less than about 1, 2, 3, 4, or 5 half-lives of the ¹O₂. In another in situ embodiment, the ¹O₂ is produced in a first reaction zone and is provided directly (e.g., in direct fluid communication without intermediate storage) from the first reaction zone to one or more additional reaction zones where the ¹O₂ is reacted with a substrate. In an embodiment, the distance between first reaction zone and one or more additional reaction zone is less than about 5, 4, 3, 2, 1, 0.5, or 0.1 meters.

The in situ reaction of ¹O₂ with the substrate may result an improved oxidation of said substrate when compared to oxidation of an otherwise identical substrate using ¹O₂ generated ex situ and later supplied to the reaction zone. In an embodiment, an improved oxidation refers to an increased amount of reaction product (i.e., oxidized substrate). As will be understood by one of ordinary skill in the art, the reaction of ¹O₂ with a substrate in situ will reduce the loss of activated oxygen that occurs through the reaction of ¹O₂ with materials other than the intended substrate or due to the decay of activated oxygen over time.

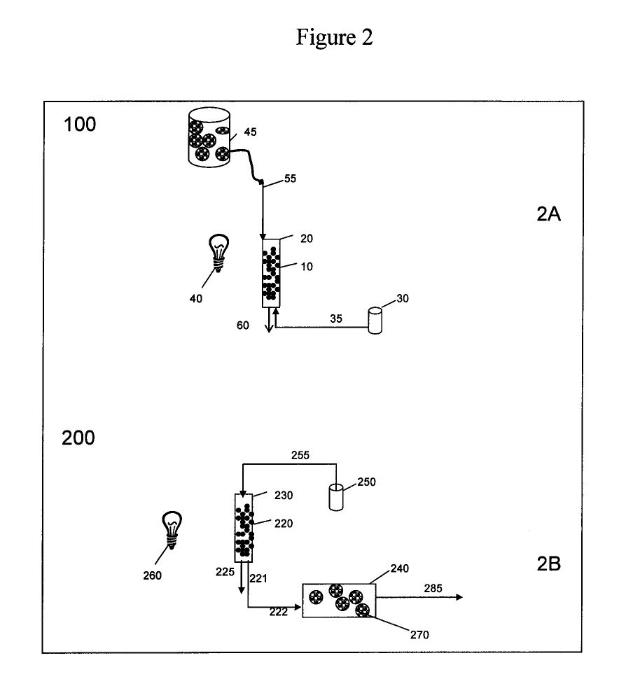

In an embodiment, a reactor design for the oxidation of a substrate using singlet oxygen generated as described herein may comprise a wet column reactor; alternatively the column design may employ a dry column reactor or a combination thereof. Embodiments of such reactor designs are illustrated in FIGS. 2A and 2B, respectively.

Referring to FIG. 2A, herein a wet column reactor 100 may comprise the catalyst 10 housed within a vessel 20 that is subjected to source of molecular oxygen 30 via flowline 35 and a light source 40. The catalyst 10 may be exposed to the light source 40 in the presence of oxygen in order to generate singlet oxygen. A feed 45 comprising substrate and other components may be introduced to vessel 20 via inlet port 55 and allowed to contact the singlet oxygen under conditions sufficient to produce an oxidized substrate that may be recovered via flowline 60.

Referring to FIG. 2B, a dry column reactor 200 may comprise the catalyst 220 housed within a vessel 230 that is in fluid communication with a second vessel 240. A source of molecular oxygen 250 may be introduced to the vessel 230 housing the catalyst via flowline 255. The catalyst 220 may be exposed to a light source 260 in the presence of oxygen in order to generate singlet oxygen. At least a portion of the singlet oxygen may enter vessel 240 via flowlines 221 and 222 and contact a substrate 270 wherein the reaction conditions in the vessel 240 are sufficient to allow for oxidation of the substrate by singlet oxygen, which may be recovered via flowline 225. In such embodiments, the length of the flowlines 221 and 222 between the vessel housing the catalyst 230 (e.g., an excitation reaction zone) and the vessel containing the substrate feed 240 (e.g., an oxidation reaction zone) may be adjusted such that the distance traveled by the singlet oxygen generated in vessel 230 is minimized. As would be understood by one of ordinary skill in the art, minimizing the length singlet oxygen has to travel before contacting the substrate reduces the loss of singlet oxygen to undesired side reactions. For example, according to the literature data, at pressures between 0.5 and 10 torr and a flow rate of generated singlet oxygen between 25 and 500 ml/min, the half-life of singlet oxygen is about one second in pure oxygen, see H. H. Wasserman and R. W. Murray, Organic Chemistry A Series of Monographs v. 40 “Singlet Oxygen”, p. 41-42, which is incorporated by reference herein in its entirety. In air the half-life of singlet oxygen is longer due to dilution of singlet oxygen with nitrogen which decreases the number of intermolecular singlet oxygen collisions that cause quenching of the excited oxygen molecules to the ground state of oxygen. In 10-20 mm tubing the gas stream takes 1 or 2 msec (milliseconds) to travel a centimeter. Consequently, the singlet oxygen can be transported a meter or two in such a flow system without great loss.

Additional devices may be included in the reactor to prevent the loss of singlet oxygen via adventitious reactions. For example, drying columns or condensation filters may be installed to reduce the amount of water present in the molecular oxygen. Singlet oxygen in water has a half-life of 2 msec, consequently the presence of water may significantly reduce the amount of singlet oxygen available to react with the substrate.

In some embodiments, the reactor vessel wherein the substrate and singlet oxygen come into contact (e.g., reactor vessel 240 in FIG. 2B) comprises a bubble type reactor. In such embodiments, an inert gas may be introduced to the reactor to create an airflow through the reactor sufficient to produce significant bubbling and foaming in the reactor. This bubbling may generate a gas-liquid interface that promotes the reaction of singlet oxygen and the substrate. In an embodiment, the airflow rate ranges from 0.5 L/min to 10 L/min, alternatively from 1 L/min to 5 L/min, alternatively from 5 L/min to 10 L/min. Additionally, inert materials such as for example glass beads may be introduced to the reactor to increase the gas-liquid interface. Such reactors have a gas-liquid interface that may be 15 to 100% higher than empty bubble column reactors. Such reactors are described in Hofmann, H., Hydrodynamics and Mass Transfer in Bubble Columns in Multiphase Chemical Reactors, Ed. Gianetto A., Silverston P. L., Springer-Verlag, 1986, p. 434, which is incorporated by reference herein in its entirety.

The oxidized substrates generated as described herein may be characterized by the presence of functionalities such as a peroxide and/or epoxide functionality. Oxidized substrates having these functionalities may serve as end-use compounds or be reacted further to produce a variety of end-use compounds.

In an embodiment, singlet oxygen is allowed to react with a substrate comprising a hydrocarbon having at least one double bond. Without wishing to be limited by theory, there appear to be three types of primary products of singlet oxygen reactions with hydrocarbons that contain one or more double bonds: endoperoxide synthesis by 1,4-addition of singlet oxygen to cis-1,3-diene systems (RXN 1); allyl hydroperoxide synthesis by “ene” reaction of singlet oxygen with a double bond system which contains at least one allylic hydrogen atom (RXN 2) and; dioxetane synthesis by 1,2-addition of singlet oxygen to an electron-donor activated double bond (RXN 3).

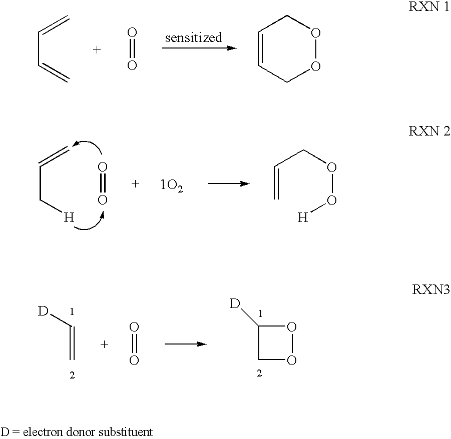

Hydroperoxides are formed in the reaction between singlet oxygen and olefins possessing an allylic hydrogen according to a concerted “ene” mechanism that requires that the double bond of the olefin be cleanly shifted into the allylic position, RXN 4. These reactions are described in B. R\dot{a}nby & J. F. Rabek, Singlet Oxygen, John Wiley & Sons, 1978, p. 116, which is incorporated by reference herein in its entirety.

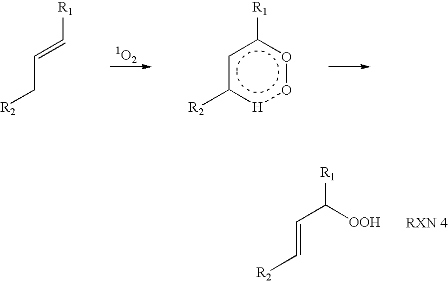

In an embodiment, the substrate comprises a diene having at least one allylic hydrogen, alternatively a 1,3-diene having at least one allylic hydrogen. Such substrates when contacted with ¹O₂ may react to form peroxides such as for example as shown in Scheme 1 which depicts the reactions of 1,3-cyclohexadiene with ¹O₂ and α-terpinene with ¹O₂, respectively.

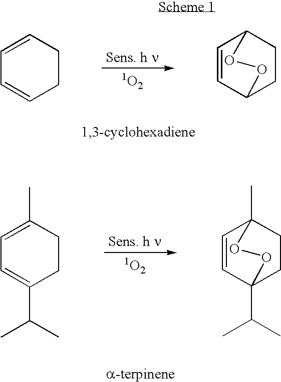

In some embodiments, the reaction of ¹O₂ with a substrate comprising a diene having at least one allylic hydrogen results in the formation of a cyclic peroxide. The cyclic peroxide may undergo a spontaneous rearrangement to form a bis epoxide ring. This is depicted in Scheme 2 which shows the reaction of indene with ¹O₂.

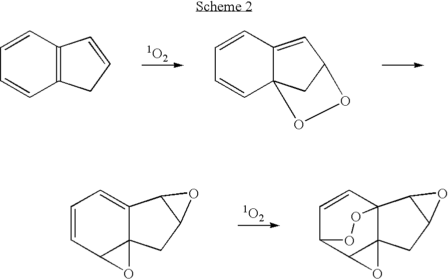

The formation of the oxidized materials (e.g., peroxides, hydroperoxides and/or epoxides) may be detected and quantified using any means for or device capable of and operable to detect and quantitate these materials. For example, the detection and quantitation of these hydroperoxides, peroxides and/or epoxides may be carried out spectroscopically using techniques such as attenuated total reflectance spectroscopy (ATR) and/or Fourier transform infrared spectroscopy (FTIR).

As will be understood by one of ordinary skill in the art, the amount of oxidized material formed using the methodologies disclosed herein will depend on a variety of factors such as the nature of the substrate (e.g., diene) used and the reaction conditions employed. Such factors may be adjusted to maximize the production of the oxidized material. For example, the peroxide may be present in an amount of from 1 μg to about 100 μg of active oxygen per 1 g of solution.

In some embodiments, the peroxide, hydroperoxide, epoxide or combinations thereof formed by the reaction of singlet oxygen with a diene as disclosed herein may function as initiators in a polymerization reaction (e.g., HIPS polymerization). Without wishing to be limited by theory, this may be due to the formation of —OOH groups that may serve as grafting sites on the rubber backbone, as described in M. L. Kaplan, P. Q. Kelleher, J. Polym. Sci. A1, 8, 3163 (1970) and J. Lucki, B. R\dot{a}nby, J. F. Rabek, Eur. Polym. Journal, v. 15, p. 1101-1110, each of which is incorporated by reference herein in its entirety.

In some embodiments, a reaction may comprise at least one diene capable of reacting with singlet oxygen as disclosed herein to form a peroxide, a hydroperoxide, an epoxide or combinations thereof that may function as initiators in a polymerization reaction. Alternatively, a reaction may comprise at least two or more different dienes capable of reacting with singlet oxygen as disclosed herein to form peroxides, hydroperoxides, epoxides or combinations thereof that may function as initiators in a polymerization reaction. In such embodiments, the two or more dienes may have a similar rate of reaction with singlet oxygen, alternatively the dienes may have differing rates of reaction with singlet oxygen.

In an embodiment, an oxidized substrate (e.g., a peroxidated diene) is prepared as disclosed herein and utilized in a polymerization process such as in the polymerization of styrene. Elastomer-reinforced polymers of monovinylidene aromatic compounds such as styrene, alpha-methylstyrene and ring-substituted styrene have found widespread commercial use. For example, elastomer-reinforced styrene polymers having discrete particles of cross-linked elastomer dispersed throughout the styrene polymer matrix can be useful for a range of applications including food packaging, office supplies, point-of-purchase signs and displays, housewares and consumer goods, building insulation and cosmetics packaging. Such elastomer-reinforced polymers are commonly referred to as high impact polystyrene (HIPS).

Methods for the production of polymers, such as HIPS, typically employ polymerization using a continuous flow process and one or more initiators as described in more detail herein. Polybutadiene elastomer is dissolved in styrene that is subsequently polymerized. During polymerization, a phase separation based on the immiscibility of polystyrene (PS) and polybutadiene (PB) occurs in two stages. Initially, the PB forms the major or continuous phase with styrene dispersed therein. As the reaction begins, PS droplets form and are dispersed in an elastomer solution of PB and styrene monomer. As the reaction progresses and the amount of polystyrene continues to increase, a morphological transformation or phase inversion occurs such that the PS now forms the continuous phase and the PB and styrene monomer forms the discontinuous phase. The reaction requires the formation of polystyrene chains in the presence of PB leading to the production of a grafted polybutadiene PS, which is essential in forming the morphology of HIPS.

In an embodiment, an oxidized substrate (e.g., one or more peroxidated dienes) is employed as an intrinsic polymerization initiator in a HIPS production process. A method for the production of HIPS may comprise the dissolution of a diene elastomer such as for example and without limitation DIENE 55 rubber in styrene. DIENE 55 rubber is a low cis butadiene rubber commercially available from Firestone. Styrene, also known as vinyl benzene, ethylenylbenzene and phenylethene is an organic compound represented by the chemical formula C₈H₈. Styrene is widely commercially available and as used herein the term styrene includes a variety of substituted styrenes (e.g., alpha-methyl styrene), ring-substituted styrenes such as p-methylstyrene as well as unsubstituted styrenes. The diene elastomer may then react with singlet oxygen to generate a peroxidated diene elastomer. In an embodiment, the peroxidated diene elastomer functions as an intrinsic initiator in a HIPS production process and no additional initiators (i.e., extrinsic initiators) may be necessary. Alternatively, one or more extrinsic initiators may be used as described herein.

In an alternative embodiment, the HIPS production process employs a diene elastomer and a second diene also having an allylic hydrogen such as for example and without limitation 1,3-cyclohexadiene. The second diene may be an elastomer, alternatively the second diene is non-elastomeric. Both the diene elastomer and the second diene may each react with singlet oxygen to form peroxide functionalities and as such the peroxidated dienes may function as intrinsic initiators in the HIPS production process. In an embodiment, the second diene may be chosen to both have an allylic hydrogen and a higher rate of reaction with singlet oxygen than that of the diene elastomer. In such an embodiment, HIPS production in the presence of both dienes is increased when compared to HIPS production in the presence of the diene elastomer alone.

In an embodiment, the HIPS production process employs at least one extrinsic initiator in addition to the intrinsic initiators formed as previously described herein. Such extrinsic initiators may function as an additional source of free radicals to enable the polymerization of styrene. In an embodiment, any initiator capable of free radical formation that facilitates the polymerization of styrene may be employed. Such initiators are well known in the art and include by way of example and without limitation organic peroxides. Examples of organic peroxides useful for polymerization initiation include without limitation diacyl peroxides, peroxydicarbonates, monoperoxycarbonates, peroxyketals, peroxyesters, dialkyl peroxides, hydroperoxides or combinations thereof. In an embodiment, the extrinsic initiator level in the reaction is given in terms of the active oxygen in parts per million (ppm). In an embodiment, the level of active oxygen level in the disclosed reactions for the production of HIPS is from 20 ppm to 80 ppm, alternatively from 20 ppm to 60 ppm, alternatively from 30 ppm to 60 ppm. The selection of extrinsic initiator and effective amount will depend on numerous factors (e.g. temperature, reaction time) and can be chosen to meet the desired needs of the process.

In an embodiment, the HIPS may also contain additives as deemed necessary to impart desired physical properties, such as, increased gloss or color. Examples of additives include without limitation chain transfer agents, talc, antioxidants, UV stabilizers, lubricants, mineral oil, plasticizers and the like. The aforementioned additives may be used either singularly or in combination to form various formulations of the HIPS. For example, stabilizers or stabilization agents may be employed to help protect the HIPS from degradation due to exposure to excessive temperatures and/or ultraviolet light. These additives may be included in amounts effective to impart the desired properties. Effective additive amounts and processes for inclusion of these additives to polymeric compositions are known to one skilled in the art.

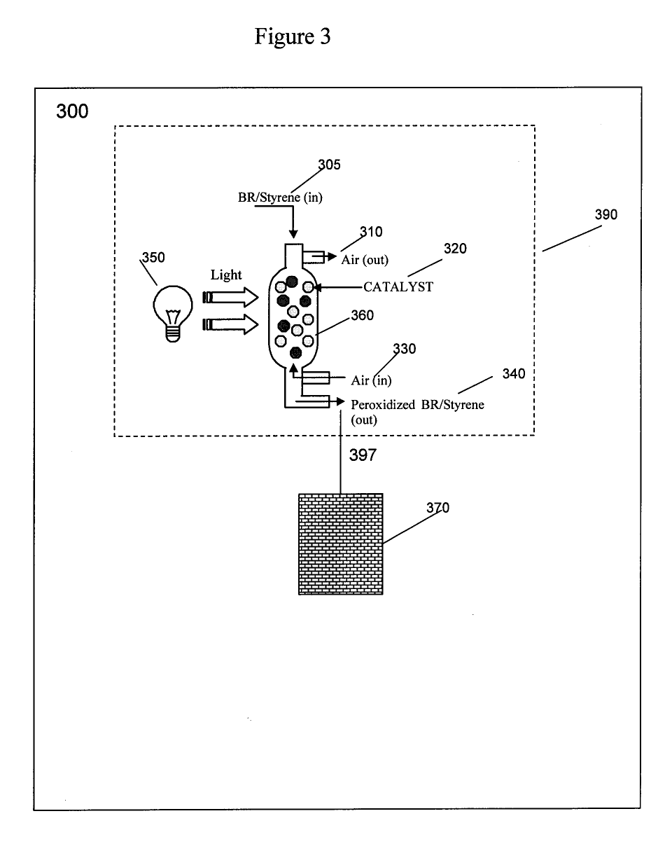

In an embodiment, the polymerization is carried out in a reactor design compatible with the in situ production of a polymerization initiator. One such reactor system 300 is shown schematically in FIG. 3. In an embodiment, the polymerization process comprises the polymerization of styrene monomer in the presence of at least one elastomer to form a HIPS. In such an embodiment, a styrene monomer, elastomer and optionally a second diene may be introduced to a single or common reaction zone (e.g., one reaction vessel).

Referring to FIG. 3, a polymerization reactor system 300 may comprise a reactor system 390 for the in situ production of a polymerization initiator and one or more additional downstream reactors 370 (e.g., polymerization reactors) coupled via flow line 397. The reaction system 390 for the in situ production of a polymerization initiator may comprise a reaction vessel 360, having one or more inlet ports 305, 330 and one or more outlet ports 310, 340. The reaction vessel 360 houses a catalyst 320 (e.g., an immobilized photosensitive dye) and may be constructed of any material compatible with the materials used in the HIPS production process (e.g., glass) and that allows for the transmission of light from the light source 350 to the photosensitive catalyst 320. While the light source 350 is depicted as being outside the reaction vessel 360, it is contemplated that the light source could be housed within an appropriate container or otherwise configured to be located within the reaction vessel 360, which would allow for the use of non-light transmissive materials (e.g., steel) for the reaction vessel 360. In an embodiment, HIPS reactants comprising a styrene monomer, a diene-elastomer and an optional second diene having at least one allylic hydrogen may be introduced to the reactor vessel 360 via inlet port 305. In some embodiments, the optional second diene may also comprise an elastomer, alternatively the optional second-diene may be non-elastomeric. A source of molecular oxygen (e.g., air) may also be introduced to the reactor vessel 360 through inlet port 330. In an embodiment, liquid reactants are fed near the top of the reactor vessel 360 and gas reactants are fed near the bottom of the reactor vessel 360 to form a bubble column reactor (e.g., a wet column) as described in more detail herein. Irradiation of the catalyst 320 by the light source 350 in the presence of molecular oxygen may result in the formation of singlet oxygen which may in turn react with the diene-elastomer and optional second diene to produce peroxidated elastomer and optional peroxidated second diene. Gases entering the vessel and/or generated during the polymerization reaction may exit the reactor via outlet port 310.

Following the formation of singlet oxygen and/or the peroxidated elastomer and optional peroxidated second diene, the reactor vessel 360 may be reconfigured (e.g., change in reaction conditions) to allow for the polymerization of styrene and the grafting of the peroxidated elastomer. In an embodiment, the reaction mixture comprises an extrinsic initiator such as described herein. The extrinsic initiator may be introduced to the reaction mixture to supplement the function of the initiators formed during the course of the polymerization reaction (e.g., peroxidated elastomer and/or peroxidated second diene) which are hereafter termed intrinsic initiators. Alternatively, the mixture comprising the peroxidated elastomer, peroxidated diene and styrene monomer may exit the reactor vessel 360 via outlet port 340 and be fed, optionally with one or more extrinsic initiators, to one or more downstream reaction vessels 370 for further processing (e.g., HIPS polymerization).

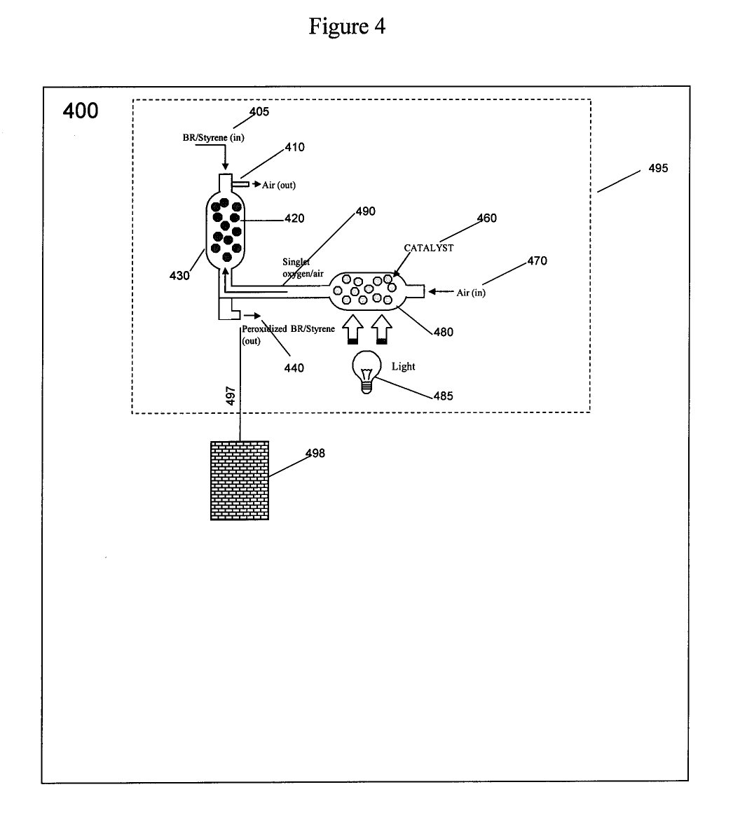

Referring to FIG. 4, a polymerization reactor system 400 may comprise a reaction system 495 for the in situ production of a polymerization inhibitor and one or more additional downstream reactors 498 (e.g., polymerization reactors) coupled via flow line 497. In such an embodiment, the reactor system 495 for the in situ production of a polymerization initiator may comprise a first reactor vessel 480 coupled to and in fluid communication (e.g., in direct fluid communication) with a second reactor vessel 430 such as to allow the transfer of materials from the first reactor vessel 480 to the second reactor vessel 430 (e.g., transfer of material in about real time with minimal or insubstantial delay).

In an embodiment, both reactor vessels 480 and 430 may be constructed of any material compatible with the materials used in the polymerization process (e.g., HIPS production). Additionally, the first reactor vessel 480 may be constructed of a material (e.g., glass) that allows light to be transmitted from the light source 485 to the catalyst 460 housed in the first reactor vessel 480. While the light source 485 is depicted as being outside the reaction vessel 480, it is contemplated that the light source could be housed within an appropriate container or otherwise configured to be located within the reaction vessel 480, which would allow for the use of non-light transmissive materials (e.g., steel) for the reaction vessel 480. The second reactor vessel 430 may be constructed of the same or different material (e.g., stainless steel) as the first reaction vessel 480.

In system 400, singlet oxygen may be generated in a first reactor vessel 480, which may be referred to as a dry column. The catalyst 460 may be irradiated with light source 485 and contacted with molecular oxygen (e.g., air) introduced via inlet port 470 to produce singlet oxygen. At least a portion of the singlet oxygen may leave the first reactor vessel 480 via an outlet port and enter the second reactor vessel 430 via flow line 490 where it may contact HIPS reactants such as for example an elastomer, an optional second diene having at least one allylic hydrogen and styrene monomer which are introduced to the second reactor vessel 430 via inlet port 405. Glass beads 420 may be used in reactor vessel 430 for increasing gas-liquid interface in the heterogeneous reaction between singlet oxygen in the gas phase and substrate (e.g., elastomer and/or optional second diene) in solution phase (liquid). Gases entering the vessel and or generated during the polymerization reaction may exit the reactor via outlet port 410. In an embodiment, liquid reactants are fed near the top of the reactor vessel 430 and gas reactants are fed near the bottom of the reactor vessel 430 to form a bubble column reactor (e.g., a wet column) as described in more detail herein.

The singlet oxygen may react with the elastomer and optional second diene to produce a peroxidated elastomer and an optional peroxidated second diene. The peroxidated elastomer and/or the optional peroxidated second diene may function as intrinsic initiators. In some embodiments, the reaction mixture may contain an extrinsic initiator as described herein. The extrinsic initiator may function to supplement the function of the intrinsic initiators (e.g., peroxidated elastomer and/or optional peroxidated second diene). The reaction conditions in the first reactor vessel 480 may differ from that in the second reactor vessel 430 such as to facilitate the reactions occurring in the respective reactor vessels. In an embodiment, the reaction conditions in second reactor vessel 430 promote partial or complete polymerization of styrene to polystyrene and the formation of HIPS. In an alternative embodiment, the styrene, peroxidated elastomer and optional peroxidated second diene may be removed from the reactor vessel 430 via outlet port 440 and may be feed to a downstream reaction vessel 498 via flow line 497 for further processing (e.g., HIPS polymerization).

### EXAMPLES

The embodiments having been generally described, the following examples are given as particular embodiments of the disclosure and to demonstrate the practice and advantages thereof. It is understood that the examples are given by way of illustration and are not intended to limit the specification or the claims in any manner.

### Example 1

Preparation of supported dye photocatalysts was carried out using an incipient wetness impregnation technique. Two levels of dye loading, 0.25 micromoles/100 g of support and 0.125 micromoles/100 g of support were prepared for each type of support. Typically, 0.010 g (or 0.005 g) of methylene blue (Alfa Aesar, high purity) was dissolved in a volume of methylene chloride equal to the pore volume of 100 g of support, from 50 cc to 78 cc. The resulting clear blue solution was added dropwise to 100 g of support, which had been placed in a round bottom flask, with shaking for homogeneous distribution of the dye. The mixture of the support and dye solution was then rotor-evaporated to remove methylene chloride.

### Example 2

Preparation of supported dye photocatalysts was carried out using an incipient wetness impregnation technique. Specifically, 4 mg of high purity methylene blue (Alfa Aesar) was dissolved in 20 ml of methylene chloride. The resulting clear blue solution was added dropwise to 100 g of amorphous silica lump 8 mesh support, which had been placed in a round bottom flask, with shaking to ensure a homogeneous distribution of the dye. The methylene chloride diluent was rotor-evaporated from the solid and the impregnated supports were placed in 65° C., pre-heated vacuum oven overnight to remove trace solvent.

### Example 3

Preparation of supported dye photocatalysts was carried out using the spray drying technique. Specifically, 2 g of high purity rose Bengal (Alfa Aesar, FW 1034) were dissolved in 70 ml of ethanol (99.5%, Aldrich). The resulting clear red solution was added to a 200 ml flask of an Aldrich chromatography flask-type sprayer. The support, 200g of alumina F200 beads (SA 200 m²/g, pore volume, 0.78 cc/g) were placed in two round aluminum foil plates in the hood. Compressed air was supplied through the Nalgen tubing connected to the sprayer. Air was supplied at a low rate that allowed slow controlled spraying of the alumina beads with the dye solution. The alumina beads were mixed during the spraying with a spatula so all the beads were covered with the dye and shaken periodically to ensure a homogeneous distribution of the dye. All of the solution in the flask was used to spray coat the dye before the solvent was removed from the support by placing the plates with the dye-sprayed photocatalyst in a vacuum oven pre-heated to 60° C. and left overnight. A reactor tube, 1.5 inches ID 44 inches long was then filled to a volume of 1 L using 800 g of the alumina beads.

### Example 4

Preparation of water-soluble supported dye photocatalysts was carried out using a spray drying technique. Specifically, 0.015 g of Acridine Orange Base (FW 265.36, 75% purity, Alfa Aesar) was dissolved in 50 ml of water acidified with the 1 ml of acetic acid. The resulting clear yellow solution was added to a 200 ml flask of an Aldrich chromatography flask-type sprayer. The support, 200 g of silica extrudate (Alfa Aesar #43860, SA 144m²/g), was placed on a round aluminum foil plate in the hood. Compressed air was supplied through the Nalgen tubing connected to the sprayer. Air was supplied at a low rate that allowed fine slow spraying of the silica beads with the dye solution which were mixed during the spraying with a spatula so all the beads were covered with the dye. The beads were shaken periodically to ensure a homogeneous distribution of the dye. All of the solution in the flask was used to spray coat the dye onto the surface of the support and was completely absorbed by the support. Solvent was removed from the support by placing the plate with the dye-sprayed photocatalyst in a vacuum oven pre-heated to 60° C. and left overnight.

### Example 5

Catalyst loading was determined for the dyes rose Bengal and acridine orange. The catalyst supports employed were silica extrudate having a surface area of 144 m²/g and alumina F200 with a surface area of 200 m²/g. Catalyst loading for acridine orange on silica was determined to range from 0.018 to 0.5 g per 100 g of support while catalyst loading for Rose Bengal ranged from 0.026 to 1.5 g per 100 g of support. Similar experiments were carried out utilizing the water soluble dyes thionine, erythrosine and methylene blue. Catalyst loading utilizing these dyes was determined to be 2 micromoles per 100 g of support. Loading of the dye per gram of support was determined by dividing the amount of the dye in the solution that was used to treat the support by the weight of the support.

### Example 6

The activity of several high efficiency dyestuffs as photocatalysts was compared. Photo hydroperoxidation process samples containing 7% of Diene-55 rubber were tested for active oxygen (hydroperoxides) according to the ASTM-D-2340 procedure for spectrophotometric determination of active oxygen. The data are reported in Table 1 in units of micrograms of active oxygen per gram of solution.

TABLE 1

| | Dye | Active | Active |
|---|---|---|---|
| | Loading, mg | oxygen | oxygen |
| Sensitizer | per 100 g of | μg per g of | μg per g of |
| And Support | support | solution | rubber |
| Acridine Orange on silica | 15 | 15.07 | 215.28 |
| extrudate | | | |
| Acridine Orange on silica | 250 | 6.39 | 98.57 |
| lump | | | |
| Rose Bengal on alumina F200 | 1000 | 2.43 | 34.71 |
| Thionine on silica extrudate | 15 | 5.08 | 72.57 |
| Erythrosin on silica extrudate | 24 | 7.05 | 100.71 |
| Methylene Blue on silica | 10 | 7.05 | 100.71 |
| extrudate | | | |

According to the Table 1, acridine orange based catalysts showed the highest efficiency although these catalysts showed a lower activity at high loading. Specifically, for acridine orange, the active oxygen measured in the 7% rubber feed solution was 15 ppm for 0.015 g/per 100 g of support loading, and 6 ppm for 0.5 g/per 10 g of support loading. The results demonstrate an increase in the peroxidation level with an increase of catalyst loading was not linear as was found by Rabek and Ranby, previously incorporated by reference herein, and excessive loading caused a decrease in oxidation rate. Without wishing to be limited by theory, this may be due to a self-quenching process occurring between pairs of excited dye molecules which is favored at high concentrations of photosensitizer.

### Comparative Example 1

A comparison of the oxidized substrate formed using a wet column reactor to that formed using a dry column reactor was made. The products from both reactors were used as polymerization initiators in a downstream polymerization process. Specifically, a wet column reactor such as that shown in FIGS. 2A or 3 was packed with a catalyst comprising methylene blue on silica lump support. Feed comprising a 4% solution of butadiene rubber in styrene monomer was trickled down into the reactor while air was supplied from the bottom through the sparger. The feed was allowed to foam under ambient light. After 2 hours the reactor was drained and peroxidized feed was collected. Another peroxidation was carried out using a dry column, such as that shown in FIGS. 2B or 4 that was packed with rose Bengal catalyst on high surface area silica support. Air was passed through this dry column which was irradiated with a source of visible light and then supplied to the bottom of a second reactor which contained the substrate to be oxidized. The second reactor additionally contained glass beads that were used to increase liquid-gas interface between the singlet oxygen, in gas phase, and the substrate in liquid. Feed comprising a 4% solution of butadiene rubber in styrene monomer was trickled down into the second column and was allowed to foam for 2 hours before the reactor was drained and the peroxidized feed collected.

The peroxidized feed was used in batch polymerization reactions for the production of HIPS. Conditions for the peroxidized formulations followed by batch polymerizations are listed below in Table 2. Peroxide levels of the peroxidation batches listed in Table 1 were determined with QUANTIFIX colorimetric dipsticks (Aldrich) which is a semi-quantitative technique that employs matching the color produced using a sample having an unknown peroxide level to a QUANTIFIX color scale which displays differing intensity of colors based on the reaction with a known quantity of peroxide. Conversions for the batch polymerizations of these formulations appear in Table 3.

TABLE 2

| | | | Catalyst | | |
|---|---|---|---|---|---|
| | | | loading, | | |
| Formu- | | | mg, per | | |
| lation | | | 100 g of | Column | Initi- |
| number | Catalyst Support | Catalyst | support | type | ator |
| 1 | none | MB | 8 | wet | TBIC, |
| | | | | | 200 |
| | | | | | ppm |
| 2 | silica gel 8 mesh | MB | 8 | wet | none |
| 3 | silica extrudate | RB | 26 | wet | none |
| 4 | silica extrudate | RB | 26 | dry | none |
| 5 | silica extrudate | RB | 26 | dry | none |
| 6 | silica extrudate | RB | 26 | dry | none |
| 7 | silica extrudate | RB | 26 | dry | none |
| 8 | silica extrudate | RB | 26 | dry | none |
| 9 | silica extrudate | AO | 6 | dry | none |
| 10 | silica extrudate | RB | 26 | dry | none |

TABLE 3

| | FORMULATION NUMBER | | | | | |
|---|---|---|---|---|---|---|
| | 1 | 2 | | 6 | 7 | |
| | (0 | (15 | 3 + 4 | (10 | (10 | 9 + 10 |
| Time, min | ppm) | ppm) | (10 ppm) | ppm) | ppm) | (15 ppm) |
| 0 | 4 | 3.5 | 3.2 | 3.3 | 3.1 | 4.2 |
| 30 | 4.3 | 5.7 | 3.7 | 4.8 | 3.2 | 6.0 |
| 60 | 8.6 | 10.9 | 7.2 | 7.5 | 6.6 | 11.2 |
| 120 | 18.6 | 19.5 | 17.3 | 15.8 | 15.3 | 21.2 |
| 180 | 47.4 | 42.0 | 37.8 | 37.5 | 36.5 | 43.0 |
| 240 | 70.0 | 66.0 | 63.8 | 66.7 | 68.1 | 62.8 |

These results show that for the feeds with peroxide levels ˜10 ppm, polymerization rates at 110° C. are comparable with the rate of baseline polymerization initiated with 200 ppm of an ex situ prepared polymerization initiator t-butylperoxy isopropyl carbonate (TBIC). Feeds with peroxidation levels ˜15 ppm showed higher conversion at 110° C. than the baseline. U.S. Pat. No. 5,595,033, incorporated by reference herein in its entirety, teaches that the percent of solids at phase inversion point determines grafting levels in HIPS. The point of phase inversion is defined by the formula s=2.5×R_{w} where s is solids percent, and R_{w} is the weight percent of rubber based on total polymerization mixture and is the sum of rubber and polymer formed (both graft and free polymer matrix). According to this definition polymerizations obtained from photo-oxidation batches 2, 9, and 10, which produced higher than baseline percent solids early in the process, may produce HIPS with higher grafting levels.

### Example 7

The hydroperoxidation of several dienes was investigated. Hydroperoxidation was carried out in a reactor design similar to that schematized in FIG. 4. Hereafter the dry column refers to the column containing the catalyst. Hydroperoxidation of 2,3-dimethyl-2-butene was carried out by adding 100 ml of 5% solution of 2,2-dimethyl-2-butene (Aldrich, 98%, boiling point (b.p.) 73° C.) in ethyl benzene to a laboratory photo-peroxidation reactor connected to a separate, “dry”, column packed with 37 g of rose Bengal catalyst (loading 0.26 mg/g of support) on silica catalyst support. Air was flown through the irradiated catalyst-packed column at 1 L/min and entered the column containing the organic substrate through a diffuser. The catalyst-containing column was irradiated with a tungsten lamp (71 ft-candles) and singlet oxygen formed on contact of air with irradiated photocatalyst. The reactor with substrate solution was sparged with singlet oxygen for two hours. After two hours, the reactor was drained and reaction product solution collected.

Hydroperoxidation of 1,3-cyclohexadiene was carried out by adding 100 ml of 5% solution of 1,3 cyclohexadiene (Aldrich, 97%, b.p. 80° C.) in ethyl benzene to a laboratory photo peroxidation reactor with dry column packed with 76 g of Rose Bengal catalyst (loading 0.26 mg/g of support) on alumina F200 (Alcoa). The column was then sparged with air at 1 L/min for two hours. The catalyst-containing, or dry column was irradiated with tungsten lamp (71 ft candles). After two hours the reactor was drained, and reaction product solution collected.

Hydroperoxidation of 1-methyl-1-cyclohexadiene, α-terpinene or 2.6-dimethyl-2,4,6,-cyclooctatriene and myrcene was carried as follows: 100 ml of a 10% solution of substrate (1-methyl-1-cyclohexadiene, Aldrich, 97%, b.p. 80° C.; indene, b.p. 181° C., Aldrich 90% technical grade; a-terpinene, b.p. 173-175° C., Aldrich, 85%; 2,6-dimethyl-2,4,6,-octacyclotriene tech. grade 80%, mixture of isomers, b.p. 73-75° C./14mm, Aldrich; myrcene, 7-methyl-3-methylene-1,6-octadiene, Aldrich, technical grade, b.p. 167° C. ) in toluene was added to a laboratory photo peroxidation reactor having dry column packed with 76 g of Rose Bengal catalyst (loading 0.26 mg/g of support) on silica. The column was then sparged with air at 1 L/min for two hours. Ambient lighting was used. During photooxidation of indene, the column with indene (i.e., FIG. 4 reaction vessel 430) was covered to prevent light-initiated polymerization of indene.

The amount of hydroperoxide formed using each of the dienes above was determined by active oxygen measurements performed in accordance with ASTM D-2340-82 and the results are shown in Table 4.

TABLE 4

| | Active Oxygen measured in 5-10% |
|---|---|
| | solutions exposed to |
| Substrate | singlet oxygen (ppm) |
| 2,3-dimethyl-2-butene 5% | 95.31 |
| 1,3-cyclohexadiene 5% | 15.06 |
| 1-methyl-cyclohexadiene 10% | 193.15 |
| α-terpinen 10% | 80.25 |
| Indene 10% | 9.93 |
| 2,6-dimethyl-2,4,6-cyclooctatriene | 226.20 |
| Myrcene | 145.51 |
| Polybutadiene | 6.34 |

The results demonstrate the ability to form peroxide functionalities by contacting photosensitizer-generated singlet oxygen with dienes having at least one allylic hydrogen.

### Example 8

The effect of in situ generated polymerization initiators on the rates of HIPS polymerization was investigated. The reactor design was similar to that shown schematically in FIG. 3. A hydroperoxidized rubber feed was prepared in the presence of 2,3-dimethyl-2-butene and 1,3-cyclohexadiene as follows: 170 ml of a 4% solution of DIENE-55 rubber in styrene was added to a photoperoxidation reactor with the catalyst column packed with Rose Bengal supported on silica. Either 5 wt % of 2,3-dimethyl-2-butene or 5 wt % of 1,3-cyclohexadiene was then added and resulting mixture was sparged with air for two hours at 1 L/min flowrate. The column was then irradiated with tungsten lamp (71 ft candles). After two hours the reactor was drained and feed was collected. It was noted that at the moment of addition of the 1,3 cyclohexadiene, the feed solution noticeably thickened.

A first control reaction containing 170 ppm of the polymerization initiator LUPEROX 233 and in the absence of either in situ polymerization initiators 2,3-dimethyl-2-butene hydroperoxide or 1,3-cyclohexadiene endoperoxide was carried out and designated as the baseline polymerization reaction. LUPEROX 233 (L233) is ethyl 3,3-d(t-butylperoxy)butyrate commercially available from ARKEMA, which serves as an organic peroxide initiator.

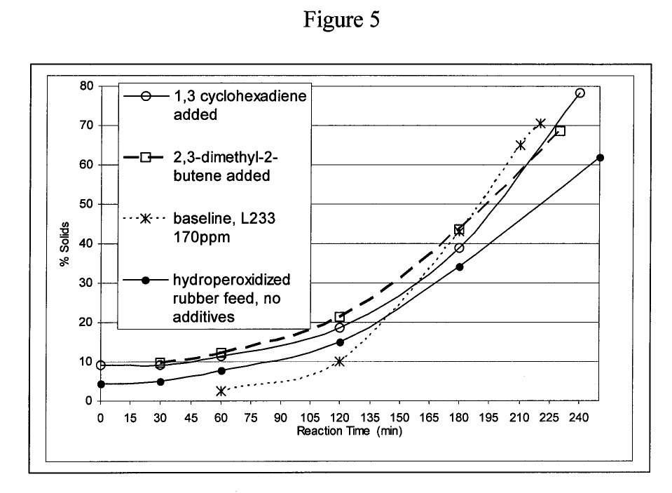

A second control reaction was carried out in the absence of both the extrinsic initiator L233 and the intrinsic initiators 2,3-dimethyl-2-butene hydroperoxide or 1,3-cyclohexadiene endoperoxide and designated “hydroperoxidized rubber feed no additives”. The feeds generated in all of these reactions were collected and subsequently used in polymerization reactions in a batch reactor using a temperature profile of 2 hours at 110° C., 1 hour at 130° C., and 1 hour at 150° C. The percent solids obtained as a function of time is given in Table 5 and plotted in FIG. 5.

TABLE 5

| | No additives | With intrinsic | With intrinsic |
|---|---|---|---|
| Time | (hydroperoxidized | initiator's precursor | initiator's precursor |
| (min) | DIENE-55 only) | 2,3,-dimethyk-2-butene | 1,3-cyclohexadiene |
| 30 | 4.99 | 9.62 | 9.19 |
| 60 | 7.88 | 12.3 | 11.4 |
| 120 | 15.11 | 21.5 | 18.52 |
| 180 | 34.05 | 43.67 | 38.8 |
| 240 | 62.08 | 78.32 | 68.52 |

These results show a significant increase in polymerization rates when in situ peroxide polymerization initiators are present in the feed. Cyclohexadiene endoperoxide and 2,3-dimethyl-2-butene hydroperoxide proved to be efficient polymerization initiators when formed in situ along with the rubber hydroperoxidation.

While various embodiments have been shown and described, modifications thereof can be made by one skilled in the art without departing from the spirit and teachings of the disclosure. The embodiments described herein are exemplary only, and are not intended to be limiting. Many variations and modifications of the embodiments disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the embodiments disclosed herein. The discussion of a reference herein is not an admission that it is prior art to the present disclosure, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A method comprising:
irradiating a donor molecule with light to form an activated donor molecule;
contacting the activated donor molecule with an acceptor molecule to form an activated acceptor molecule; and
contacting the activated acceptor molecule with a substrate to generate an oxidized substrate, wherein the donor molecule is in the solid phase and the activated acceptor molecule is in the gas phase.

2. The method of claim 1 wherein the donor molecule comprises a photosensitizer and the acceptor molecule comprises molecular oxygen.

3. The method of claim 1 wherein the activated acceptor molecule comprises an activated oxygen species.

4. The method of claim 2 wherein the photosensitizer comprises a photosensitive dye.

5. The method of claim 4 wherein the photosensitive dye comprises a xanthene dye, a thiazine dye, an acridine dye or combinations thereof.

6. The method of claim 2 wherein the photosensitive dye is present in an amount of from 0.01 g/per 100 g of support to 2.5 g/per 100 g of support.

7. The method of claim 1 wherein the light has a wavelength of from 300 nm to 1400 nm.

8. The method of claim 1 wherein the activated acceptor molecule comprises singlet oxygen (¹O₂).

9. The method of claim 1 wherein the substrate comprises a diene.

10. The method of claim 9 wherein the diene comprises an elastomeric diene, a diene having an allylic hydrogen, or both.

11. The method of claim 1 wherein the oxidized substrate comprises a peroxide, a hydroperoxide, an epoxide or combinations thereof.

12. The method of claim 1 wherein the irradiating and the contacting occur in situ.

13. A method comprising:
contacting molecular oxygen with an activated photosensitizer to produce singlet oxygen;
contacting the singlet oxygen with at least one diene to produce an oxidized diene; and
contacting at least one monomer and the oxidized diene under conditions suitable for the formation of a polymer.

14. A method comprising:
irradiating molecular oxygen and a photosensitizer with light to form an activated oxygen species; and
contacting the activated oxygen species with a substrate to form an oxidized substrate, wherein the irradiating and contacting occur in situ.

15. A method comprising:
contacting a photosensitive dye with a support to generate a supported photocatalyst; and
contacting the supported photocatalyst with molecular oxygen in the presence of a light source to produce an activated oxygen species.

16. A method comprising:
spraying a photosensitive dye on a silica support to form a supported photosensitive dye;
drying the supported photosensitive dye; and
irradiating the supported photosensitive dye in the presence of molecular oxygen to produce singlet oxygen.

17. A method comprising:
contacting a photosensitive dye with a support under conditions suitable to generate a supported photosensitive dye;
contacting the supported photosensitive dye with a substrate and molecular oxygen to from a reactive mixture; and
irradiating the reactive mixture with light under conditions suitable to form an oxidized substrate.

18. A method comprising:
contacting molecular oxygen with an activated photosensitizer in a reaction zone to produce singlet oxygen;
contacting the singlet oxygen with at least one diene in the reaction zone to produce at least one oxidized diene; and
contacting a styrene monomer with the oxidized diene under conditions suitable for the formation of a styrene polymer.

19. A method comprising:
contacting molecular oxygen with an activated photosensitizer to produce singlet oxygen in a first reaction zone;
contacting the singlet oxygen with at least one diene to produce an oxidized diene in a second reaction zone; and
contacting a styrene monomer with the oxidized diene under conditions suitable for the formation of a styrene polymer.

20. A method comprising:
contacting molecular oxygen with an activated photosensitizer to produce singlet oxygen;
contacting the singlet oxygen with at least one diene to produce at least one oxidized diene, wherein the singlet oxygen is produced and reacted with the diene in situ; and
contacting a styrene monomer with the oxidized diene under conditions suitable for the formation of a styrene polymer.
